(19) United States
(12) Patent Application Publication
(10) Pub. No.: US 2025/0389143 A1
(43) Pub. Date: Dec. 25, 2025

(54) QUICK RELEASE LATCH FOR A DOOR HANDLE

(71) Applicants: Eli Conner, Lindsay, OK (US); Isaac Estepp, Blanchard, OK (US); Matthew Henderson, Blanchard, OK (US)

(72) Inventors: Eli Conner, Lindsay, OK (US); Isaac Estepp, Blanchard, OK (US); Matthew Henderson, Blanchard, OK (US)

(21) Appl. No.: 19/247,873

(22) Filed: Jun. 24, 2025

Related U.S. Application Data
(60) Provisional application No. 63/663,402, filed on Jun. 24, 2024.

(51) Int. Cl. E05C 17/02

(52) U.S. Cl. CPC E05C 17/02

(57) ABSTRACT

A latch for a door handle has a housing and a pair of latch members. The housing has a handle receiving slot extending from a first end toward a second end and from a top side toward a bottom side. Each of the latch members has a latch face extending into the handle receiving slot in an opposing relationship to one another, and the latch faces are biased toward one another.

### CROSS-REFERENCE TO RELATED APPLICATIONS

The present application claims priority to the provisional patent application identified by U.S. Ser. No. 63/663,402, filed on Jun. 24, 2024.

### BACKGROUND

Students, faculty, and parents in the American school system have concerns about the rising number of school shootings, which is approximately 8.5 times higher now than it was twenty years ago. If a school shooting occurs, teachers must do a lockdown procedure: the first thing to do is to lock the door, which can take a great deal of time when under a large amount of stress.

The safety of schools has become an enormous concern, pushing society to look closely at the measures in place to protect students and teachers. With the United States facing escalating school violence, schools have adopted various security measures, including the use of school resource officers (SROs), enhanced access control, and surveillance systems. Despite these efforts, recent statistics reveal a concerning trend. In the 2019-2020 school year, 97% of public schools reported controlled access, 91% used security cameras, and 77% implemented badges or picture IDs to bolster safety. However, the prevalence of SROs did not decrease the severity of school shootings. Instead, the choice of firearms used in such incidents proved a direct correlation with the number of casualties, prompting a reevaluation of firearm accessibility. This data shows the need for a comprehensive approach to school safety that addresses specific weak points, such as the effectiveness of door lock mechanisms within classrooms.

The Sandy Hook Advisory Commission's 2015 report highlights the critical role of doors that lock from the inside in securing classrooms. The tragic events at Marjory Stoneman Douglas High School in 2018 showed the risks associated with exterior locking doors, as teachers faced injury or death while trying to secure classrooms from the outside. Incidents, such as the 2012 Sandy Hook massacre and the Uvalde, Texas shooting, show the urgency of the issue. In these cases, inadequate door locks proved to be a fatal flaw, enabling shooters to gain access quickly. The financial constraints hindering schools from upgrading door locks raise concerns. However, the stark reality of 1,054 school shootings in the past decade, with a significant surge in 2022 alone, shows the need for prioritizing resources for enhanced security measures. Addressing the inadequacies of door lock systems becomes not just a matter of funding but a crucial step in safeguarding the well-being of students and educators in the face of an alarming rise in school shootings.

Mass shootings in public spaces, especially in schools, have been on a steep incline in the last ten years. Younger victims, including teens and college-age students, are the most at risk. The shooting in Uvalde, TX, lasted 78 minutes when the shooter locked himself in two adjoining classrooms, killing 21. When there is a school shooter on the property, they go door to door, checking if the doors are unlocked. They can find unlocked doors because of the absurd time it takes to lock them. Reducing the time to lock classroom doors, regardless of what type of lock, would make every classroom safer.

Schools are given a certain amount of money to ensure their safety and health. Throughout the United States, 795 billion dollars was funded to schools during the years 2019-2020, and education spending statistics show that only 10% of this money went towards renovations that involved school safety. When considering changing a lock, four things must be regarded: budget, structure, the type of door, and the door frame. There are hundreds of doors within a single school that would require maintenance. Additionally, 1 in 4 schools lack interior locking doors, which contributes to the already substantial number of doors that would require this type of maintenance. Replacing all the door locks is an economically unsound investment and sometimes impossible due to the building's structure.

In the United States, the need for improved security in school systems has increased significantly over the last decade. However, the need for higher security causes distress in students. It has been evaluated, and there is an obvious correlation with more cameras being installed, leading to a need for more communication between students because they are constantly being watched. Data have shown that schools with cameras correlate to lower test scores and more suspensions on average than other schools in the area without cameras. These are all excellent examples of how security impacts students' education in their daily lives.

People have already attempted to solve this problem and have begun implementing various solutions within schools. The primary enhancements they have implemented include RFID scanners, electronic locks, and bulletproof glass.

These safety measures have become commonplace within the American school system, but sometimes they do not provide the level of security they need. The primary issue with most previous solutions that comply with codes and regulations is that they do not address individual doors. When a school tries to protect its students, it typically uses measures that regulate who can enter, such as an RFID scanner. Prioritizing individual classroom safety would significantly reduce the casualties and injuries caused by school emergencies.

RFID scanners are commonplace in modern-day school buildings to protect the students inside. In most cases, each student has an ID badge that allows them to access the doors on the building's perimeter. Despite being effective at keeping non-students out, it cannot prevent a student with bad intentions from entering. These scanners are also only installed on the perimeter doors, which means that if an intruder gains access to the inside of the building, there is a period when students in the classrooms are at risk. These scanners are also ADA-compliant. Prices for RFID scanners can vary significantly, as every school or facility has a different number of perimeter doors and a varying number of students per year. Each scanner can cost from $1,500 to $3,000. Door installation costs can vary due to different scanners and the number of doors in each school. Antennas set up a LAN network that communicates between the hardware and software. Software and licensing will also be a fee when using RFID scanners in a facility. Price should not be a deciding factor in a school's safety.

Electronically controlled bolt locks, such as the SpaceSaver® Mortise Bolt Locks, can solve the problem. While the bolt locks would work quickly to secure every door on campus, installing them on every door would be too expensive. They cost between $200 and $500, a hefty fee, but not as much as other solutions. It would be much more feasible to place it on the entrance and exit doors, similar to the RFID scanners.

The installation of the bolt lock is possible for all kinds of doors. All that is needed for installation is a mortise cut, which is likely in most situations. These bolts are also known for their longevity, which is a significant benefit compared to RFID. The price of the bolt is the only downside of this solution, as it would not protect individual classrooms like the team wants. Having locks on exterior doors will likely not safeguard any students if the threat comes from another student.

Bulletproof glass or film can keep students safe in a classroom but has downsides. The primary drawback of installing bulletproof glass in classrooms is its cost-effectiveness. DefenseLite bulletproof glass is utilized in various scenarios to safeguard individuals. This glass ranges in price from $30 to $100, depending on the thickness of the glass used. While this option is less expensive than the others, the installation is significantly more complex than that of the electronic lock. The old glass must be replaced with new bulletproof glass and sealed around the entire frame.

Glass installation can be costly for schools that lack grant money or have limited funds. Most classrooms do not have glass in the first place, and the installation of glass can raise privacy concerns for students. This solution does not make doors any more secure, as it does not affect the locking mechanism.

Schools have already installed protective measures individually, including electronic locks, RFID scanners to allow entry to the building, and bulletproof glass. However, significant issues with these proposed solutions make them less commonplace.

Electronic locks for classroom doors are powered locks that can be controlled manually or remotely. They come in various shapes and sizes, including deadbolt-style, strike, and magnetic locks. To install this product, the interior of the door must be hollowed out, and then the lock must be set in and wired. The price is a whopping $426 per lock, which is the main issue with this solution.

RFID scanners detect radio waves sent with an encryption key released by a microchip. This is commonly used to unlock doors by scanning a nametag with an embedded microchip. Installing these systems requires extensive mounting and electrical work; each badge must be purchased and assigned the encryption key. At over $200 per control unit, then an added fee for each badge used, the cost and installation add to the rarity of these systems in a school setting.

Bulletproof glass is a thicker laminated polycarbonate glass with a softer protective coating on the surface. More layers are added to increase the rating of the bullet it can withstand. The average bulletproof glass can stop three rounds from a 9 mm or three rounds from a .357 Magnum. Installation requires breaking away the old glass, setting the new one in, and sealing it with silicone. Bulletproof glass costs the consumer around $100 per square foot of material, making cost the central issue.

Though all these earlier attempts to solve this issue have been well-planned and executed, they have not decreased the rate at which people are dying in these tragic events. For this reason, the exorbitant amount of money spent on these projects was wasted. Real progress has yet to be made toward solving the issue of individual classroom safety. A more cost-effective solution is needed that effectively accomplishes what each of these solutions aims to do, to improve American schools.

Many classroom doors today use a security lock that includes a latch bolt that is retracted by the knob/handle from either side of the door unless the outside is locked by a key. When locked, the outside knob/handle is rendered inoperable, but the inside knob/handle is always free for immediate exit or egress. An auxiliary latch deadlocks the latch bolt when the door is closed.

One approach for school safety has been to lock the door whenever students are in the classroom. The problem with this is that it can be disruptive for teachers and students who frequently enter and exit the classroom, as the teacher must open the door for everyone. On the other hand, if the door is left unlocked in a passage mode for convenience and the need for lockdown arises, the teacher must locate the classroom door key, open the door, and step into the hallway to lock it from the outside. This places the classroom at risk and can take critical time away from other lockdown procedures, such as shutting off lights, pulling down window shades, and covering the door window.

It would be beneficial to provide a device by which the door can remain in a locked mode while allowing individuals to enter and exit the classroom in a non-lockdown situation freely, but allow the lock to be quickly locked without the need for a key, thereby eliminating the time it takes to find the door key, open the door, lock the door from the outside, and step back into the classroom, all steps that compromise the safety of both the teacher and the students in the room. It is to such a device that the inventive concepts disclosed herein are directed.

### BRIEF DESCRIPTION OF THE DRAWINGS

FIG. 1 is a perspective view of a latch mounted to a door with a first door handle in a bolt-extending position.

FIG. 2 is a perspective view of the latch of FIG. 1 holding the first door handle in a bolt-retracting position.

FIG. 3 is a perspective view of an exemplary latch for a door handle constructed in accordance with the inventive concepts disclosed herein.

FIG. 4 is a top-plan view of the latch of FIG. 3.

FIG. 5 is a perspective view of a first portion of a housing of the latch.

FIG. 6 is a perspective view of a second portion of the housing of the latch.

FIG. 7 is a perspective view of a latch member.

FIG. 8 is a top-plan view of the latch member of FIG. 7.

FIG. 9 is a perspective view of another embodiment of a latch member.

FIG. 10 is a side elevational view of the latch member of FIG. 9.

FIG. 11 is a perspective view of the latch mounted to a door with a door handle in a latched position.

FIG. 12 is a perspective view of the door handle of FIG. 11 shown being moved from the latched position.

FIG. 13 is a perspective view of the latch mounted to a door with the door handle moved to an unlatched position.

FIG. 14 is a perspective view of the door handle of FIG. 11, shown in the unlatched position.

FIG. 15 is a perspective view of a door handle with a flat, rectangular shape.

FIG. 16 is a perspective view of another embodiment of a latch for a door handle constructed in accordance with the inventive concepts disclosed herein.

FIG. 17 is a perspective view of another embodiment of a latch for a door handle constructed in accordance with the inventive concepts disclosed herein.

FIG. 18 is a perspective view of another embodiment of a latch for a door handle constructed in accordance with the inventive concepts disclosed herein.

### DETAILED DESCRIPTION OF EXEMPLARY EMBODIMENTS

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. The inventive concepts disclosed herein are capable of other embodiments or being practiced or carried out in various ways. Also, it is to be understood that the phraseology and terminology employed herein are for the purpose of description and should not be regarded as limiting the inventive concepts disclosed and claimed herein in any way.

In the following detailed description of embodiments of the inventive concepts, numerous specific details are set forth to provide a more thorough understanding of the inventive concepts. However, it will be apparent to one of ordinary skill in the art that the inventive concepts within the instant disclosure may be practiced without these specific details. In other instances, well-known features have not been described in detail to avoid unnecessarily complicating the instant disclosure.

As used herein, the terms “comprises,” “comprising,” “includes,” “including,” “has,” “having,” and any variations thereof are intended to have a non-exclusive inclusion. For example, a process, method, article, or apparatus that comprises a list of elements is not necessarily limited to only those elements and may include other elements not expressly listed or inherently present therein.

Unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B is true (or present).

In addition, use of the “a” or “an” are employed to describe elements and components of the embodiments disclosed herein. This is done merely for convenience and to give a general sense of the inventive concepts. This description should be read to include one or at least one and the singular also includes the plural unless it is obvious that it is meant otherwise.

As used herein, qualifiers like “substantially,” “about,” “approximately,” and combinations and variations thereof are intended to include not only the exact amount or value they qualify but also some slight deviations therefrom, which may be due to manufacturing tolerances, measurement error, wear and tear, stresses exerted on various parts, and combinations thereof, for example.

Finally, as used herein, any reference to “one embodiment” or “an embodiment” means that a particular element, feature, structure, or characteristic described in connection with the embodiment is included in at least one embodiment. The phrase “in one embodiment” appearing in various places in the specification does not necessarily refer to the same embodiment.

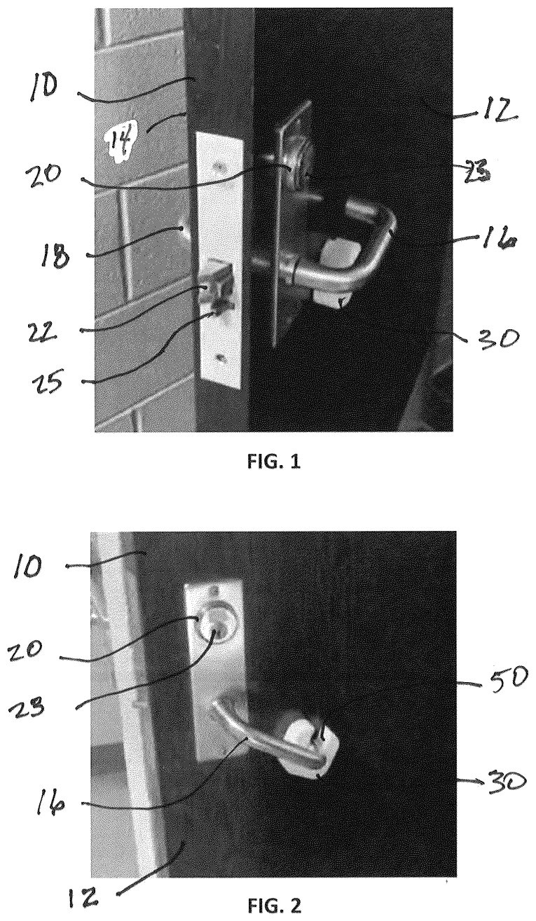

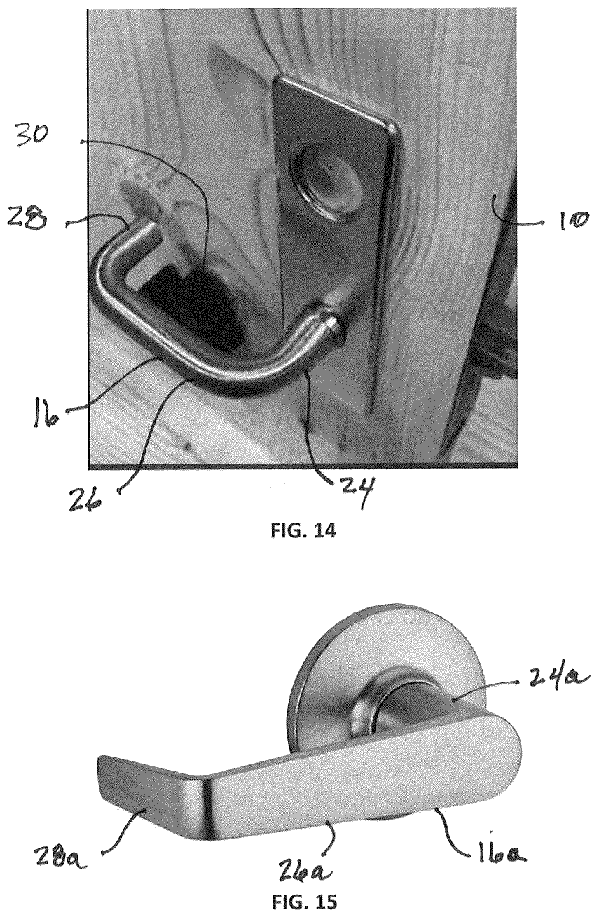

Referring now to the drawings, and more particularly to FIGS. 1 and 2, a door 10 is illustrated. The door 10 is mounted on hinges (not shown) and has an interior side 12 and an exterior side 14, with a first door handle 16 on the interior side and a second door handle 18 on the exterior side. A lock assembly 20 is operable between a locked condition and an unlocked condition. In the unlocked condition, a bolt 22 is operable between an extended position (FIG. 1), wherein the bolt 22 is received in an opening of a strike plate (not shown) and a retracted position (FIG. 2), wherein the bolt 22 is retracted into the door 10. Each of the first door handle 16 and the second door handle 18 is independently rotatable between a bolt-extending position (FIGS. 1 and 14), wherein the bolt 22 is in the extended position, and a bolt-retracting position (FIGS. 2 and 11), wherein the bolt 22 is in the retracted position. In the locked condition, the second door handle 18 is rendered inoperable with the bolt 22 engaged with the strike plate. The first door handle 16 is rotatable between the bolt-extending position and the bolt-retracting position, so the first door handle 16 can be used to disengage the bolt 22 from the strike plate and open the door 10 for ingress or egress. The lock assembly 20 may have a keyway 23 on the exterior side 14 only (not visible in FIG. 1), the lock assembly 20 may have a keyway 23 on the the exterior side 14 and the interior side 12. The lock assembly 20 may also have an auxiliary bolt 25.

In one version best illustrated illustrated in FIGS. 14, the first door handle 16 may have a round or tubular shape with a first portion 24 extending perpendicular from the door 10, a second portion 26 extending substantially parallel to the door 10, and a third portion 28 extending back toward the door 10.

In another version illustrated in FIG. 15, a first door handle 16a may have a flat, rectangular shape with a first portion 24a extending perpendicular from the door 10, a second portion 26a extending substantially parallel to the door 10, and a third portion 28a extending back toward the door 10.

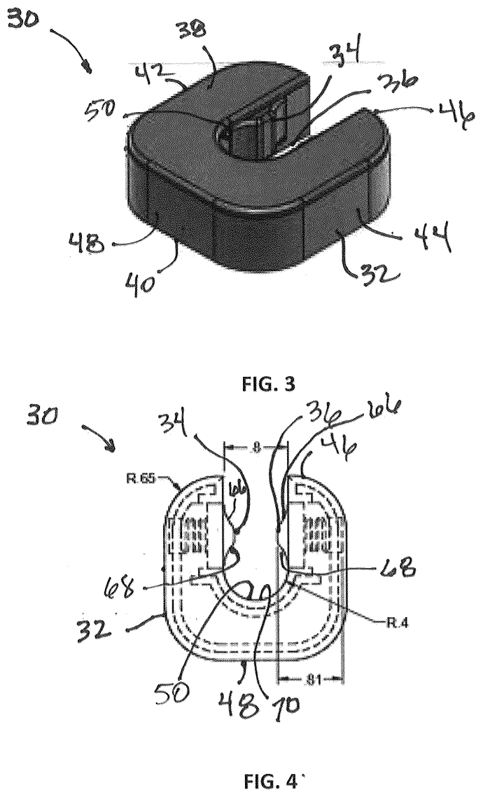

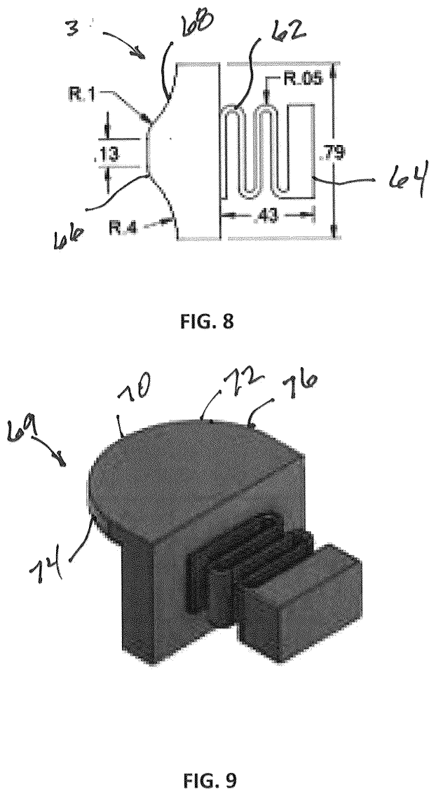

Referring to FIGS. 3-8, a latch 30 for releasably holding the first door handle 16 in the bolt-retracting position is illustrated. Broadly, the latch 30 has a housing 32, a first latch member 34, and a second latch member 36.

The housing 32 has a top side 38, a bottom side 40, a first side 42, a second side 44 opposite the first side 42, a first end 46, a second end 48 opposite the first end 46, and a handle receiving slot 50 extending from the first end 46 toward the second end 48 and extending from the top side 38 to the bottom side 40. The housing 32 is mountable to the interior side of the door, so at least a portion of the first door handle 16, (e.g., the third portion) is received in the handle receiving slot 50 when the first door handle 16 is in the bolt-retracting position (FIG. 2). With most door handles this requires the housing 32 be mounted to the door 10 with the handle receiving slot 50 at an angle of approximately 30 degrees relative to vertical, but it will be appreciated that the latch 30 may be mounted at varying angles depending on the dimensions of the door handle.

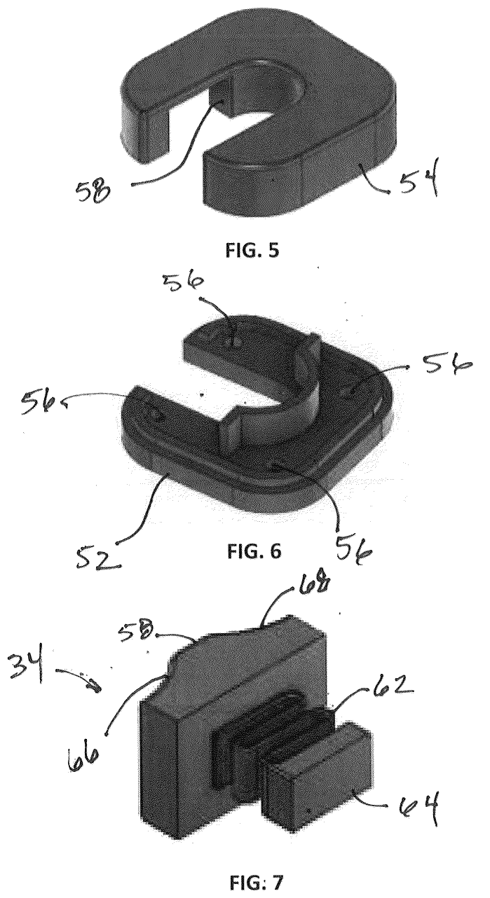

The housing 32 may be formed of two or more pieces, as best illustrated in FIGS. 5 and 6. In one embodiment, the housing 32 may have a base portion 52 and a shell portion 54. The base portion 52 may be provided with holes 56 for mounting the base portion 52 to the door 10 with suitable fasteners, such as screws. The shell portion 56 is connectable to the base portion 52 (e.g., snap-fit) and may include a pair of recesses 58 for receiving the first latch member 34 and the second latch member 36, respectively.

The first latch member 34 has a first latch face 58 extending into the handle receiving slot 50, and the second latch member 36 has a second latch face 60 extending into the handle receiving slot 50 in an opposing relationship to the first latch face 58 of the first latch member 34. The first latch member 34 and the second latch member 36 are biased or urged toward one another to releasably hold the first door handle 16 in the bolt-retracting position when the first door handle 16 is in the handle receiving slot 50. In one embodiment, the first latch member 34 and the second latch member 36 each include a spring 62 to provide two points of contact on the door handle so that the door handle is the only object manipulated when latching and unlatching the door handle. The springs may be any suitable compression spring. In one embodiment, the springs may be 3D-printed compressible layers, so the spring is formed as a single piece with the first latch face 58 and the second latch, and may include a base portion 64. Alternatively, any suitable spring may be used.

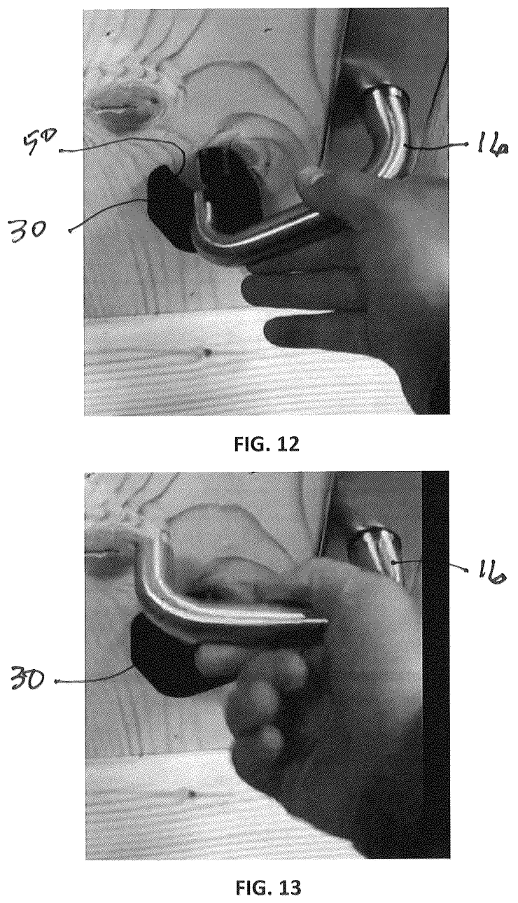

Each of the first latch face 58 and the second latch face 60 may be formed to have a leading curved surface 66 and a trailing curved surface 68 to facilitate engagement with the first door handle 16. The trailing curved surfaces 68 are spaced from a closed end 70 of the handle receiving slot 50, so the door handle seats between the trailing curved surfaces 68 and the closed end 70 of the handle receiving slot 50 when the first door handle 16 is held by the latch 30 (FIGS. 2 and 12). The leading curved surfaces 66 facilitate retraction of the first latch face 58 and the second latch face 60 as the first door handle 16 engages the latch 30.

While the springs may be formed or selected that provide varied holding strength for the door handle, in one exemplary embodiment, the springs should have a strength that requires less than about four pounds of force, but preferably less than about 3.5 pounds of force to latch and unlatch the first door handle 16 so that it does not hinder everyday use.

The latch 30 may be formed from various materials. One version may be formed from acrylonitrile butadiene styrene plastic (ABS). ABS has a low melting point, enabling its use in 3D printing or injection molding. It is very impact-and chemical-corrosion-resistant, and its rigidity allows for a long-lasting product.

Another option is polylactic acid plastic (PLA). PLA has a slightly higher melting point than ABS but is more chemically resistant. It has the same impact resistance and rigidity as ABS. PLA takes over 80 years to decompose and is more difficult to repurpose than ABS. PLA is made from natural ingredients, including corn, sugarcane, and beet pulp.

Aluminum is a more expensive yet more durable material. It is a low-density metal that can be easily machined or cast into a mold, which limits production to casting with a mold. Aluminum is highly corrosion-resistant, so it lasts 200-500 years.

Stainless steel is a durable material. It is highly corrosion-resistant and is impervious to rust. Stainless steel is a recyclable material, making it an environmentally friendly choice. It is cast into a mold, which makes the product.

Many classroom lock assemblies require the bolt 22 to release or retract when the first door handle 16 (i.e., the interior door handle) is rotated. This feature allows the first door handle, 16, to be held by the latch, 30, so the lock assembly is in a passive, unlatched mode, allowing students and staff to enter and exit the classroom without disrupting the lesson. However, if the door must be secured, such as in a lockdown situation, all that is required is for the first door handle 16 to be rotated upwardly out of the latch 30, which causes the first door handle 16 to return to the bolt-extending position (FIGS. 1, 13, and 14) where the bolt 22 is in the extended position to secure the door 10.

The latch 30 allows the door 10 to be in a passive mode but enables the door 10 to be secured much more quickly than if a staff member were required to locate a key and insert the key into the keyway 23 to secure the door 10. In one test, the latch 30 was shown to reduce the time to secure the door by about four times compared to a door locked from inside the classroom. This reduction is even more apparent compared to a door locked from the outside, which is almost seven times the difference.

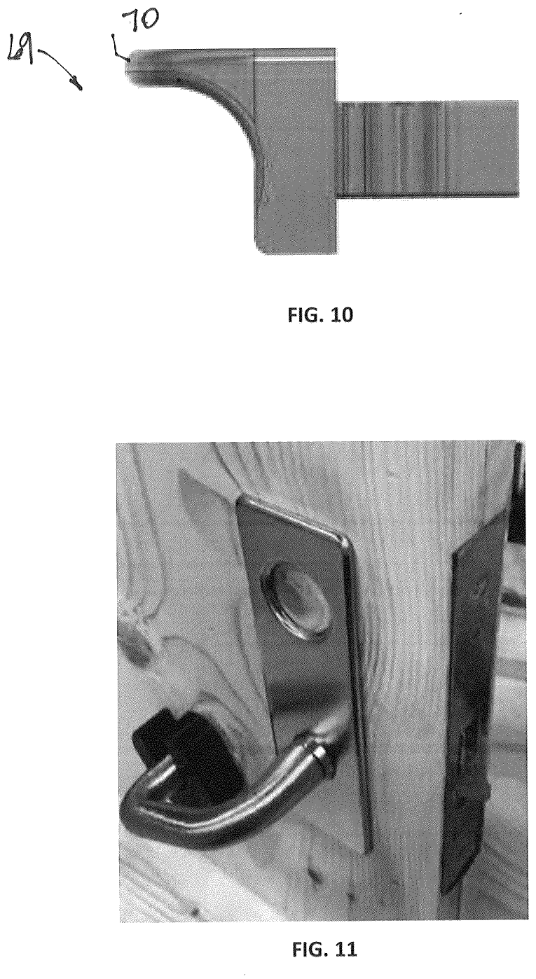

FIGS. 9 and 10 illustrate another embodiment of a latch member 69 suitable for use with a door handle 16a that has a flat, rectangular shape (FIG. 15). The latch member 69 has a latch face 70 that includes a semi-circle 72 with a leading curved surface 74 and a trailing curved surface 76. In one embodiment, the radius of the semicircle is about 4 inches. In one version, the length of the spring and the latch face is 1.025 inches. When installed, the latch members 69 are 2.05 inches long, leaving a 1/10-inch clearance between the contact points. Since the spring compresses a total of 0.06 inches, any handle up to 0.22 inches wide can fit inside the latch.

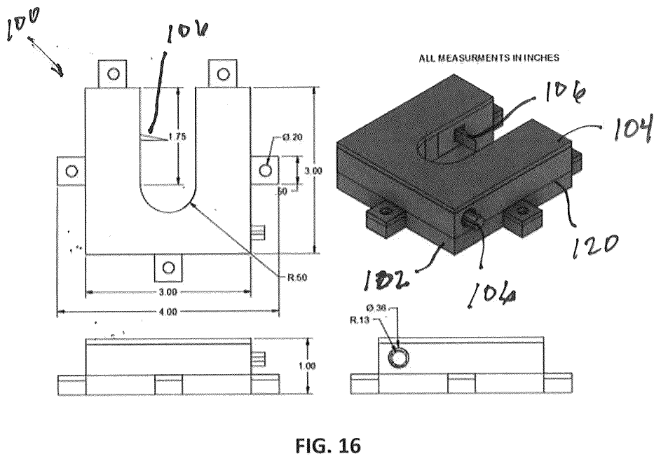

FIG. 16 illustrates another embodiment of a latch 100 constructed in accordance with the inventive concepts disclosed herein. The latch 300 includes a base 102, a cover 104, and a hook/button 106. The base 102 may have a plurality of screw holes and a hollowed area for the hook/button 106 to rest. Space is provided for a spring to relax between the base wall and the hook.

The latch 300 utilizes a 30-degree angle to allow the door handle to slide into the latch 300 when the door handle is in use. A release mechanism is controlled by the outward tension of the springs. The part that holds the door handle also protrudes from the right-hand side of the mechanism. When the button is pressed, the spring compresses, causing the entire part to move. This allows the door handle to return to its latched state.

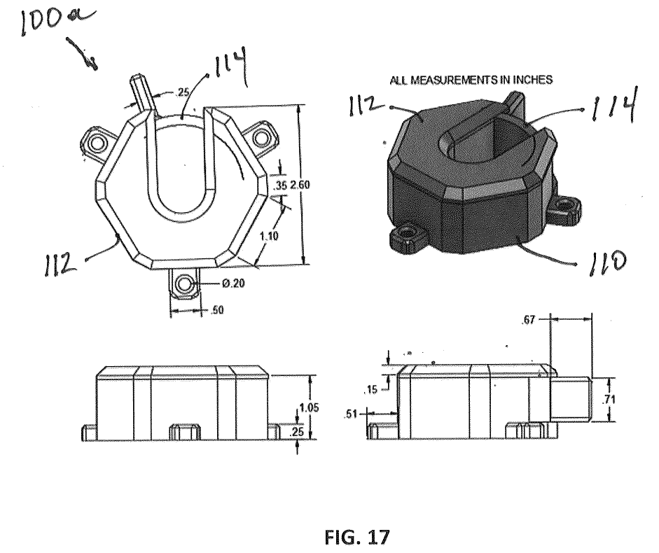

FIG. 17 illustrates another embodiment of a latch 100a constructed in accordance with the inventive concepts disclosed herein. The latch 300a has a base 110, a lid 112, and a lever 114. The base 110 contains a plurality of screw holes and space for the lever 114 to rest inside. The lever 114 has an open position and a closed position. In use, the door handle is inserted into the base, and the lever is slid over the handle.

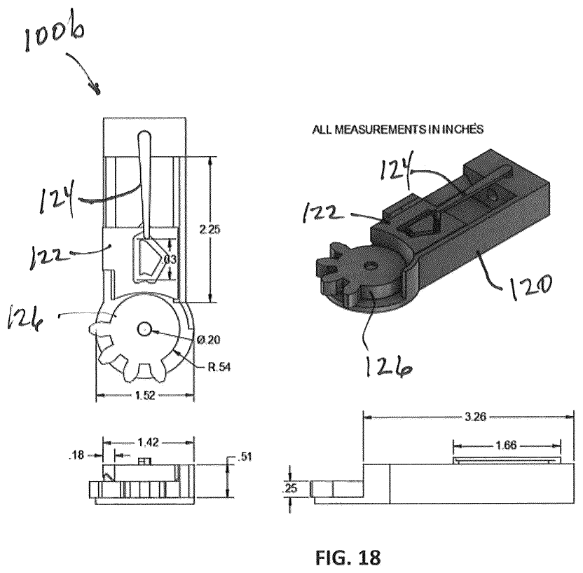

FIG. 18 illustrates another embodiment of a latch 100b constructed in accordance with the inventive concepts disclosed herein. The latch 100b has a body 120, a cam 122, a follower 124, and a gear 126. The latch 100b takes advantage of 45-degree angles, which allows parts of the design to be printed together. The latch 300b operates by bringing the door handle down, thereby pushing the cam down. When the cam is fully down, the follower locks the cam in place. While this happens, the gear turns and locks the door handle into place. To latch the door handle again, the cam is pushed down to unlock it, returning everything to its original state.

From the above description, it is clear that the inventive concepts disclosed and claimed herein are well adapted to carry out the objects and to attain the advantages mentioned herein, as well as those inherent in the invention. While exemplary embodiments of the inventive concepts have been described for purposes of this disclosure, it will be understood that numerous changes may be made that will readily suggest themselves to those skilled in the art and which are accomplished within the spirit of the inventive concepts disclosed and/or defined in the appended claims.

What is claimed is:

1. A latch for a door handle, comprising:
a housing having a top side, a bottom side, a first side, a second side opposite the first side, a first end, and a second end opposite the first end, and a handle receiving slot extending from the first end toward the second end and extending from the top side toward the bottom side;
a first latch member having a first latch face extending into the handle receiving slot; and
a second latch member having a second latch face extending into the handle receiving slot in an opposing relationship to the first latch face of the first latch member,
wherein the first latch face and the second latch face are biased toward one another.

2. The latch of claim 1, wherein each of the first latch face and the second latch face has a leading curved surface and a trailing curved surface.

3. A latch in combination with a door having an interior side and an exterior side, a first door handle on the interior side and a second door handle on the exterior side, and a lock assembly operable between a locked condition and an unlocked condition, in the locked condition the first door handle movable between a bolt-extending position wherein a bolt of the lock assembly extends from the door and a bolt-retracting position wherein the bolt is retracted into the door, the latch comprising:
a housing having a top side, a bottom side, a first side, a second side opposite the first side, a first end, and a second end opposite the first end, and a handle receiving slot extending from the first end toward the second end and extending from the top side toward the bottom side, the housing mounted to the interior side of the door so at least a portion of the first door handle is received in the handle receiving slot when the first door handle is in the bolt-retracting position;
a first latch member having a first latch face extending into the handle receiving slot; and
a second latch member having a second latch face extending into the handle receiving slot in an opposing relationship to the first latch face of the first latch member,
wherein the first latch face and the second latch face are biased toward one another to releasably hold the first door handle in the bolt-retracting position when the first door handle is in the handle receiving slot.

4. The combination of claim 3, wherein each of the first latch face and the second latch face has a leading curved surface and a trailing curved surface.
